(19) United States
(12) Patent Application Publication
(10) Pub. No.: US 2021/0301113 A1
(43) Pub. Date: Sep. 30, 2021

(54) RESIN COMPOSITION AND RESIN MOLDED ARTICLE

(71) Applicant: FUJIFILM BUSINESS INNOVATION CORP., Tokyo (JP)

(72) Inventor: Yuto HANIOKA, Kanagawa (JP)

(73) Assignee: FUJIFILM BUSINESS INNOVATION CORP., Tokyo (JP)

(21) Appl. No.: 16/986,488

(22) Filed: Aug. 6, 2020

(30) Foreign Application Priority Data
Mar. 25, 2020 (JP) 2020-055091

(51) Int. Cl. C08L 23/12; C08L 23/06; C08K 3/34; C08K 5/521; C08K 7/00

(52) U.S. Cl. CPC C08L 23/12; C08L 23/06; C08K 2201/005; C08K 5/521; C08K 7/00; C08K 3/34

(57) ABSTRACT

A resin composition includes: a polyolefin; a plate-shaped mineral; and a phosphate ester, wherein a content of the plate-shaped mineral is from 5 parts by mass to 70 parts by mass with respect to 100 parts by mass of the polyolefin, and a content of the phosphate ester is from 5 parts by mass to 45 parts by mass with respect to 100 parts by mass of the polyolefin.

### CROSS-REFERENCE TO RELATED APPLICATIONS

This application is based on and claims priority under 35 USC 119 from Japanese Patent Application No. 2020-055091 filed Mar. 25, 2020.

### BACKGROUND

### (i) Technical Field

The present invention relates to a resin composition and a resin molded article.

### (ii) Related Art

JP-A-2016-186025 proposes “a polyolefin resin composition containing (A) 40% to 98% by mass of a polyolefin resin, (B) 30% to 1% by mass of lignophenol, and (C) 30% to 1% by mass of a polyhydroxyalkanoate, provided that a total of the components (A), (B), and (C) is 100% by mass”.

JP-A-2015-113365 proposes “a flame-retardant polyolefin resin composition obtained by melting and kneading (A) a polyolefin resin, (B) an amine phosphate salt containing at least one of piperazine pyrophosphate and piperazine polyphosphate and at least one of dimelamine pyrophosphate, melamine pyrophosphate, and melamine polyphosphate, (C) a master batch obtained by melting and kneading polytetrafluoroethane, and (D) a phosphate ester compound”.

### SUMMARY

Aspects of non-limiting embodiments of the present disclosure relate to a resin composition containing a polyolefin, a plate-shaped mineral, and a phosphate ester, from which a resin molded article having excellent flame retardancy and mechanical strength is obtainable as compared with a case where a content of the plate-shaped mineral is less than 5 parts by mass or more than 70 parts by mass with respect to 100 parts by mass of the polyolefin, or a content of the phosphate ester is less than 5 parts by mass or more than 45 parts by mass with respect to 100 parts by mass of the polyolefin.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address any of the advantages described above.

According to an aspect of the present disclosure, there is provided a resin composition, including:

a polyolefin;

a plate-shaped mineral; and

a phosphate ester,

wherein a content of the plate-shaped mineral is from 5 parts by mass to 70 parts by mass with respect to 100 parts by mass of the polyolefin, and

a content of the phosphate ester is from 5 parts by mass to 45 parts by mass with respect to 100 parts by mass of the polyolefin.

### DETAILED DESCRIPTION

Hereinafter, an exemplary embodiment that is an example of the present invention will be described. These descriptions and examples are illustrative of the exemplary embodiments and are not intended to limit the scope of the invention.

In the numerical ranges described in stages in this specification, the upper limit or lower limit described in one numerical range may be replaced with the upper limit or lower limit of the numerical ranges described in other stages. Further, in the numerical ranges described in this specification, the upper limit or the lower limit of the numerical ranges may be replaced with the values described in the examples.

Each component may include plural corresponding substances.

In a case where plural substances corresponding to the component are present in the composition, unless otherwise specified, the amount of the component in the composition means the total amount of the plural substances present in the composition.

<Resin Composition>

The resin composition according to the exemplary embodiment contains a polyolefin, a plate-shaped mineral, and a phosphate ester.

The content of the plate-shaped mineral is from 5 parts by mass to 70 parts by mass with respect to 100 parts by mass of the polyolefin, and the content of the phosphate ester is from 5 parts by mass to 45 parts by mass with respect to 100 parts by mass of the polyolefin.

The resin composition according to the exemplary embodiment has the above-mentioned configuration, so that a resin molded article having excellent flame retardancy and mechanical strength may be obtained.

The reason is presumed as follows.

By adding from 5 parts by mass to 45 parts by mass of the phosphate ester, which is a flame retardant, to 100 parts by mass of the polyolefin, the flame retardancy of the resin composition is improved.

On the other hand, when a resin molded article is produced by using a resin composition obtained by blending the phosphate ester with the polyolefin, the mechanical strength of the resin molded article may decrease.

In order to improve the mechanical strength of the resin molded article, for example, if a spherical filler is blended in the resin composition, the flame retardancy may decrease.

Therefore, as the resin composition according to the exemplary embodiment, a resin molded article having excellent flame retardancy and mechanical strength may be obtained by blending from 5 parts by mass to 45 parts by mass of phosphate ester with respect to 100 parts by mass of the polyolefin, and from 5 parts by mass to 70 parts by mass of the plate-shaped mineral with respect to 100 parts by mass of the polyolefin, to the polyolefin. The reason is presumed that the distribution of the plate-shaped mineral and the flame retardant in the resin molded article is improved.

Therefore, it is presumed that the resin composition according to the exemplary embodiment has excellent flame retardancy, and a resin molded article having excellent mechanical strength may be obtained by using the resin composition.

In addition, the resin composition according to the exemplary embodiment contains the plate-shaped mineral, so that the migration and precipitation (hereinafter, also referred to as “bleed”) of the components contained therein on the surface of the resin molded article are prevented.

The reason is presumed as follows.

By containing the plate-shaped mineral in the resin composition, the components contained in the resin composition (such phosphate ester) are prevented from reaching the surface of the resin molded article, that is, a reaching distance to the surface is lengthened, and thereby, it is less likely to migrate and precipitate on the surface.

Therefore, it is presumed that the resin composition according to the exemplary embodiment contains the plate-shaped mineral to prevent bleeding on the resin molded article.

(Polyolefin)

The polyolefin is a resin having a repeating unit derived from olefin.

The polyolefin is obtained by addition polymerization of olefin.

Moreover, an olefin monomer for obtaining the polyolefin may be one kind or two or more kinds thereof.

The polyolefin may be a copolymer or a homopolymer.

Further, the polyolefin may be linear or may have a branched chain.

Here, examples of the olefin monomer include linear or branched aliphatic olefins and alicyclic olefins.

The number of carbon atoms of the olefin is preferably from 2 to 10, and more preferably from 2 to 5.

Examples of the aliphatic olefin include α-olefins such as ethylene, propylene, 1-butene, 1-hexene, 4-methyl-1-pentene, 1-octene, 1-decene, 1-hexadecene, and 1-octadecene.

Examples of the alicyclic olefin include cyclopentene, cycloheptene, norbornene, 5-methyl-2-norbornene, tetracyclododecene, and vinylcyclohexane.

Among them, propylene is preferable from the viewpoint of improvement of the flame retardancy and the mechanical strength.

The polyolefin may have a repeating unit derived from a monomer other than the olefin monomer.

The monomer other than the olefin monomer is selected from known addition-polymerizable compounds.

Examples of the addition-polymerizable compounds include styrenes such as styrene, methylstyrene, α-methylstyrene, β-methylstyrene, t-butylstyrene, chlorostyrene, chloromethylstyrene, methoxystyrene, styrenesulfonic acid, and salts thereof; (meth)acrylic acid esters such as alkyl (meth)acrylate, benzyl (meth)acrylate, and dimethylaminoethyl (meth)acrylate; halovinyls such as vinyl chloride; vinyl esters such as vinyl acetate and vinyl propionate; vinyl ethers such as vinyl methyl ether; vinylidene halides such as vinylidene chloride; and N-vinyl compounds such as N-vinylpyrrolidone.

The content of the olefin monomer in the polyolefin is preferably 90% by mass or more, more preferably 95% by mass or more, and still more preferably 100% by mass, with respect to the monomers constituting the polyolefin.

The melt mass flow rate (abbreviated as MFR) molecular mass of the polyolefin is not particularly limited, and may be determined according to the kinds of resins, molding conditions, application to the resin molded article, and the like. For example, the MFR of the polyolefin is preferably in a range of 2 (g/10 min) to 55 (g/10 min), and more preferably in a range of 5 (g/10 min) to 35 (g/10 min).

Note that, based on JIS K7210:1999, the melt mass flow rate (MFR) of polyolefin means a value obtained by converting the amount of resins extruded from a die in a certain time by using Melt Indexer F-F01 (manufactured by Toyo Seiki Seisaku-sho, Ltd.) under the specified load conditions into the amount of resins extruded in 10 minutes. The load conditions are 230° C. and 2.16 kg for polypropylene and 190° C. and 2.16 kg for polyethylene.

The content of the polyolefin is preferably from 70% by mass to 100% by mass, more preferably from 85% by mass to 100% by mass, and still more preferably from 90% by mass to 100% by mass with respect to the mass of the entire resin composition.

(Plate-Shaped Mineral)

The resin composition according to the exemplary embodiment contains a plate-shaped mineral.

Examples of the plate-shaped mineral include salts of an ion of metal, such as aluminum, sodium, calcium, or magnesium, and silicic acid.

Specific examples thereof include kaolin minerals, montmorillonite, talc, pyrophyllite, vermiculite, saponite, bentonite, and mica.

Among them, talc is preferable from the viewpoint of improvement of the flame retardancy and the mechanical strength.

The plate-shaped mineral contained in the resin composition may be one kind or two or more kinds thereof.

In the plate-shaped mineral, from the viewpoint of the improvement of the flame retardancy and the mechanical strength, it is preferable that a major axis is from 0.1 μm to 40 μm, a minor axis is from 0.1 μm to 40 μm, and a thickness is from 0.1 μm to 3.0 μm, it is more preferable that the major axis is from 1 μm to 30 μm, the minor axis is from 1 μm to 30 μm, and the thickness is from 0.1 μm to 2.0 μm, and it is still more preferable that the major axis is from 2 μm to 15 μm, the minor axis is from 1 μm to 15 μm, and the thickness is from 0.1 μm to 1.5 μm.

Here, the major axis, minor axis, and thickness of the plate-shaped mineral are obtained by measuring five values with respect to each of minor axis, major axis, and thickness of the plate-shaped mineral by observing the internal structure of the molded article with by a scanning electron microscope (SEM) and averaging the values.

The major axis represents a maximum length when observing the surface of the plate-shaped mineral (that is, the surface perpendicular to the thickness direction).

The minor axis represents the maximum length of the lengths along the direction perpendicular to the major axis. The thickness represents the length along the direction perpendicular to the minor axis and the major axis.

The content of the plate-shaped mineral is from 5 parts by mass to 70 parts by mass with respect to 100 parts by mass of the polyolefin.

The content of the plate-shaped mineral is preferably from 10 parts by mass to 45 parts by mass, and more preferably from 15 parts by mass to 30 parts by mass, with respect to 100 parts by mass of the polyolefin, from the viewpoint of the improvement of the flame retardancy and the mechanical strength.

The mass ratio (plate-shaped mineral/phosphate ester) of the content of the plate-shaped mineral to the content of the phosphate ester is preferably from 10/1 to 1/10, more preferably from 5/1 to 1/5, and still more preferably 3/1 to 1/3, from the viewpoint of the improvement of the flame retardancy and the mechanical strength.

(Phosphate Ester)

The resin composition according to the exemplary embodiment contains a phosphate ester (including condensed phosphate ester).

Examples of the phosphate ester include trimethyl phosphate, triethyl phosphate, tributyl phosphate, tri(2-ethylhexyl) phosphate, tributoxyethyl phosphate, triphenyl phosphate, tricresyl phosphate, trixylenyl phosphate, tris(isopropylphenyl) phosphate, tris (phenylphenyl) phosphate, trinaphthyl phosphate, cresyldiphenyl phosphate, xylenyldiphenyl phosphate, diphenyl (2-ethylhexyl) phosphate, di(isopropylphenyl) phenyl phosphate, monoisodecyl phosphate, 2-acryloyloxyethyl acid phosphate, 2-methacryloyloxyethyl acid phosphate, diphenyl 2-acryloyloxyethyl phosphate, diphenyl-2-methacryloyloxyethyl phosphate, melamine phosphate, dimelamine phosphate, melamine pyrophosphate, triphenyl phosphine oxide, tricresyl phosphine oxide, diphenyl methane phosphonate, and diethyl phenyl phosphonate.

Examples of the condensed phosphate ester include an aromatic condensed phosphate ester such as bisphenol A type, biphenylene type, and isophthal type.

Specific examples of the aromatic condensed phosphate ester include compounds represented by the following Formula (I) or Formula (II).

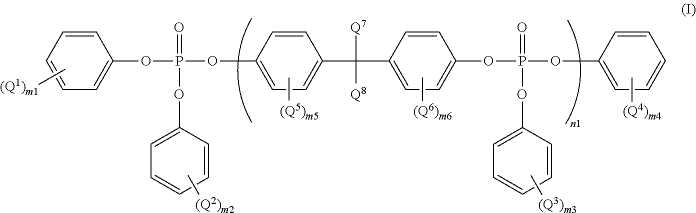

In Formula (I), Q¹, Q², Q³, and Q⁴ each independently represent an alkyl group having 1 to 6 carbon atoms, Q⁵ and Q⁶ each represent a methyl group, Q⁷ and Q⁸ each represent a methyl group, m1, m2, m3, and m4 each independently represent an integer of from 0 to 3, m5 and m6 each independently represent an integer of from 0 to 2, and n1 represent an integer of from 0 to 10.

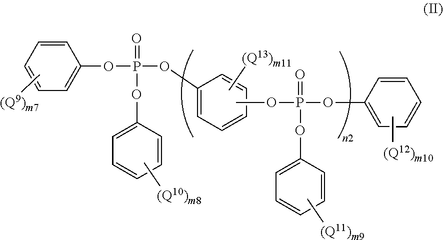

In Formula (II), Q⁹, Q¹⁰, Q¹¹ and Q¹² each independently represent an alkyl group having 1 to 6 carbon atoms, Q¹³ represents a methyl group, m7, m8, m9, and m10 each independently represent an integer of from 0 to 3, m11 represents an integer of from 0 to 4, and n2 represents an integer of from 0 to 10.

The aromatic condensed phosphate ester may be a synthetic product or a commercially available product.

Specific examples of commercially available aromatic condensed phosphate esters include commercially available products (“PX-200”, “PX-201”, “PX-202”, “CR-741”, and the like) produced by Daihachi Chemical Industry Co., Ltd.), and commercially available products (“ADK STAB FP-600”, “ADK STAB FP-800”, “ADK STAB FPR”, and the like) produced by Adeka.

The phosphate ester is preferably the condensed phosphate ester from the viewpoint of the improvement of the flame retardancy and the mechanical strength.

The phosphate ester contained in the resin composition may be one kind or two or more kinds thereof.

The content of the phosphate ester is from 5 parts by mass to 45 parts by mass with respect to 100 parts by mass of the polyolefin.

The content of the phosphate ester is preferably from 5 parts by mass to 35 parts by mass, and more preferably from 15 parts by mass to 32 parts by mass, with respect to 100 parts by mass of the polyolefin, from the viewpoint of the improvement of the flame retardancy and the mechanical strength.

(Other Components)

The resin composition according to the exemplary embodiment may further contain components other than those described above, if necessary. Examples of other components include a compatibilizer, a plasticizer, an antioxidant, a release agent, a light resistance agent, a weather resistance agent, a coloring agent, a pigment, a modifier, an anti-drip agent, an antistatic agent, an antihydrolysis agent, and a filler. The content of these components is preferably from 0% by mass to 5% by mass with respect to the entire resin composition. Here, “0% by mass” means that other components are not contained.

The resin composition according to the exemplary embodiment may contain a resin other than the polyolefin. However, other resins may be blended as long as the flame retardancy and the mechanical strength do not decrease.

Specifically, the content of the other resins is preferably 10% by mass or less with respect to the total amount of the polyolefin and other resins.

Examples of the other resins include known thermoplastic resins in the art, specifically, a polypropylene resin; a polyester resin; a polyphenylene ether resin; a polyphenylene sulfide resin; a polysulfone resin; a polyether sulfone resin; a polyarylene resin; a polyetherimide resin; a polyacetal resin; a polyvinyl acetal resin; a polyketone resin; a polyetherketone resin; a polyetheretherketone resin; a polyarylketone resin; a polyethernitrile resin; a liquid crystal resin; a polybenzimidazole resin; a polyparabanic acid resin; a vinyl polymer or copolymer resin obtained by polymerizing or copolymerizing one or more vinyl monomers selected from the group consisting of an aromatic alkenyl compound, methacrylic acid ester, acrylic acid ester, and a vinyl cyanide compound; a diene-aromatic alkenyl compound copolymer resin; a vinyl cyanide-diene-aromatic alkenyl compound copolymer resin; aromatic alkenyl compound-diene-vinyl cyanide-N-phenylmaleimide copolymer resin; a vinyl cyanide-(ethylene-diene-propylene (EPDM))-aromatic alkenyl compound copolymer resin; polyolefin; and a vinyl chloride resin; and a chlorinated vinyl chloride resin. These resins may be used alone or in combination of two or more.

The resin composition according to the exemplary embodiment may contain a flame retardant other than the phosphate ester. Other flame retardants are not particularly limited and may be known ones in the related art, and examples thereof include a phosphorus flame retardant, a sulfuric acid flame retardant, a nitrogen flame retardant, an inorganic hydroxide flame retardant, a halogen flame retardant, and a silicone flame retardant.

(Method for Producing Resin Composition)

The resin composition according to the exemplary embodiment is produced, for example, by melting and kneading a mixture of the above components. In addition, the resin composition according to the exemplary embodiment is produced, for example, by dissolving the above components in a solvent. Examples of the melting and kneading unit include known units, and specific examples thereof include a twin-screw extruder, a HENSCHEL MIXER, a BANBURY MIXER, a single-screw extruder, a multi-screw extruder, and a KO-KNEADER.

<Resin Molded Article>

The resin molded article according to the exemplary embodiment is formed of the resin composition according to the exemplary embodiment. That is, the resin molded article according to the exemplary embodiment has the same composition as the resin composition according to the exemplary embodiment.

Specifically, the resin molded article according to the exemplary embodiment is obtained by molding the resin composition according to the exemplary embodiment. The molding method may be, for example, injection molding, extrusion molding, blow molding, hot press molding, calendar molding, coating molding, cast molding, dipping molding, vacuum molding, and transfer molding.

The molding method of the resin molded article according to the exemplary embodiment is preferably injection molding because of its high degree of freedom in shape. The resin composition according to the exemplary embodiment has good fluidity, and injection molding may be applied. The injection molding may be performed using a commercially available apparatus such as NEX150 manufactured by Nissei Plastic Industry Co., Ltd., NEX70000 manufactured by Nissei Plastic Industry Co., Ltd., or SE50D manufactured by Shibaura Machine Co., Ltd.

The Charpy impact strength of the resin molded article according to the exemplary embodiment is preferably 6 or more, more preferably 8 or more, and still more preferably 10 or more, from the viewpoint of the improvement of the mechanical strength.

Here, the Charpy impact strength (kJ/m²) is measured by using a notched ISO multipurpose dumbbell test piece, with an impact resistance tester (DG-5, manufactured by Toyo Seiki Seisaku-sho, Ltd.) according to the method specified in JIS K 7111-1 (2012).

The resin molded article according to the exemplary embodiment is suitably used for applications such as electronic/electrical equipment, office equipment, home appliances, automobile interior materials, toys, and containers. Specific applications of the resin molded article according to the exemplary embodiment include housings of electronic/electrical equipment or home appliances; various parts of electronic/electrical equipment or home appliances; interior parts of automobiles; block-assembled toys; plastic model kits; CD-ROM or DVD storage cases; tableware; beverage bottles; food trays; wrap materials; films; and sheets.

### Examples

Hereinafter, examples will be described, but the present invention is not limited to these examples. In the following description, “parts” and “%” are all based on mass unless otherwise specified.

<Production of Resin Composition and Resin Molded Article>

### Examples 1 to 13 and Comparative Examples 1 to 5

The materials having the compositions indicated in Tables 1 and 2 are charged into a twin-screw kneading apparatus (TEX41SS manufactured by Shibaura Machine Co., Ltd.) and kneaded at a cylinder temperature of 230° C. to obtain resin compositions 1 to 13 and C1 to C5.

The resin compositions 1 to 13 and C1 to C5 are respectively charged into an injection molding equipment (NEX150 manufactured by Nissei Plastic Industry Co., Ltd.), and ISO multipurpose dumbbell test piece (test part length 100 mm, width 10 mm, thickness 4 mm) and a UL test piece (length 125 mm, width 13 mm, thickness 0.5 mm/1.6 mm) are produced at cylinder temperature of 230° C. and mold temperature of 40° C., and set as resin molded articles A1 to A13 and AC1 to AC5. The mold temperature is set to a low temperature by circulating water in the mold.

<Evaluation Test>

(Flame Retardancy Test)

By using a cone calorimeter (CCM, manufactured by Toyo Seiki Seisaku-sho, Ltd., product name: MCM), the resin compositions obtained in Examples and Comparative Examples are subjected to a flame retardancy test by the following method to determine the total calorific value.

As a specific test method, the measurement is performed by molding a test sample having a size of 30 mm×30 mm and a thickness of 2 mm by a melt press, and setting the radiation amount to 25 W and the distance between the cone and the sample to 30 mm.

The evaluation criteria are as follow.

—Evaluation Criteria—

A: Total calorific value is 7.5 kJ/cm² or less

B: Total calorific value is more than 7.5 kJ/cm² and 8.0 kJ/cm² or less

C: Total calorific value is more than 8.0 kJ/cm²

(Strength Evaluation Test)

The Charpy impact strength (kJ/m²) is measured by using a notched ISO multipurpose dumbbell test piece, with an impact resistance tester (DG-5, manufactured by Toyo Seiki Seisaku-sho, Ltd.) according to the method specified in ISO 7111 (2012).

The evaluation criteria are as follows.

—Evaluation Criteria—

A: Charpy impact strength more than 10 kJ/m²

B: Charpy impact strength is from 6 kJ/m² to 10 kJ/m²

C: Charpy impact strength is less than 6 kJ/m²

(Bleed Resistance Evaluation Test)

A UL test piece is allowed to stand still in a thermohydrostat (ARL-1100-J manufactured by ESPEC Corp.) set at a temperature of 60° C. and a humidity of 95% RH. After 72 hours, the UL test piece is taken out from the thermohydrostat. Then, the surface of the UL test piece is visually observed to evaluate the bleed resistance. The evaluation criteria are as follows.

A: No liquid bleed and no fog caused due to bleed

B: Fog due to bleed on a part of surface

C: Fog due to bleed on the entire surface

In Tables 1 and 2, “type” indicates a material type of polyolefin, plate-shaped mineral, or phosphate ester.

In Tables 1 and 2, “parts” indicate parts by mass of polyolefin, plate-shaped mineral, or phosphate ester in the resin composition.

In Tables 1 and 2, “%” indicates % by mass of the content of the polyolefin with respect to the mass of the total resin composition.

In Tables 1 and 2, “major axis/minor axis/thickness” indicates the major axis, minor axis, and thickness of the plate-shaped mineral from the left.

In Tables 1 and 2, “plate-shaped mineral/phosphate ester” means the mass ratio (plate-shaped mineral/phosphate ester) of the plate-shaped mineral content to the phosphate ester content in the resin composition.

Note that, the material types in Tables 1 and 2 are as follows.

—Polyolefin—
PP: Polypropylene (MFR=14 (g/10 min), J-750HP, produced by Prime Polymer Co., Ltd.)
LLDPE: Linear low density polyethylene (MFR=5 (g/10 min), UJ960, produced by Japan polyethylene Corporation.)

—Plate-Shaped Minerals—
M1: Talc (P-3, produced by Nippon Talc Co., Ltd.)
M2: Mica (SJ-005, produced by Yamaguchi Mica Co., Ltd.)
M3: Calcium carbonate (SCP-E #11100, produced by Sankyo Milling Co., Ltd.)

—Phosphate Ester—
P1: Phosphate ester (CR-741, produced by Daihachi Chemical Industry Co., Ltd.)
P2: Phosphate ester (PX-200, produced by Daihachi Chemical Industry Co., Ltd.)
P3: Phosphate ester (ADK STAB PFR, produced by Adeka)

TABLE 1

| | | | | | | | | | | | Plate- | | | |
|---|---|---|---|---|---|---|---|---|---|---|---|---|---|---|
| | | | | | Filler | | | | | | shaped | | | |
| | | | | | | | | Major axis/ | Phosphate | | minerals/ | Evaluation | | |
| | Compo- | Polyolefin | | | | | | Minor axis/ | ester | | Phosphate | Flame | | Bleed |
| Example | sition | Types | Parts | % | Types | Parts | Shapes | Thickness | Types | Parts | ester | retardancy | Charpy | resistance |
| Example 1 | 1 | PP | 100 | 73 | M1 | 25 | Plate- | 10/1/0.3 | P1 | 13 | 2.0 | B | B | A |
| | | | | | | | shaped | | | | | | | |
| Example 2 | 2 | PP | 100 | 70 | M1 | 25 | Plate- | 10/1/0.3 | P1 | 19 | 1.3 | A | A | A |
| | | | | | | | shaped | | | | | | | |
| Example 3 | 3 | PP | 100 | 64 | M1 | 25 | Plate- | 10/1/0.3 | P1 | 31 | 0.8 | A | A | A |
| | | | | | | | shaped | | | | | | | |
| Example 4 | 4 | PP | 100 | 59 | M1 | 25 | Plate- | 10/1/0.3 | P1 | 44 | 0.6 | A | B | A |
| | | | | | | | shaped | | | | | | | |
| Example 5 | 5 | PP | 100 | 91 | M1 | 5 | Plate- | 10/1/0.3 | P1 | 5 | 1.0 | B | B | A |
| | | | | | | | shaped | | | | | | | |
| Example 6 | 6 | PP | 100 | 47 | M1 | 70 | Plate- | 10/1/0.3 | P1 | 45 | 1.6 | B | B | A |
| | | | | | | | shaped | | | | | | | |
| Example 7 | 7 | PP | 100 | 73 | M1 | 25 | Plate- | 10/1/0.3 | P1 | 13 | 1.6 | B | B | A |
| | | | | | | | shaped | | | | | | | |
| Example 8 | 8 | PP | 100 | 68 | M1 | 13 | Plate- | 10/1/0.3 | P1 | 35 | 0.4 | A | B | A |
| | | | | | | | shaped | | | | | | | |
| Example 9 | 9 | PP | 100 | 63 | M1 | 25 | Plate- | 10/1/0.3 | P1 | 35 | 0.7 | A | B | A |
| | | | | | | | shaped | | | | | | | |
| Example 10 | 10 | LLDPE | 100 | 70 | M1 | 25 | Plate- | 10/1/0.3 | P1 | 19 | 1.3 | B | B | A |
| | | | | | | | shaped | | | | | | | |
| Example 11 | 11 | PP | 100 | 70 | M2 | 25 | Plate- | 10/5/0.4 | P1 | 19 | 1.3 | A | B | A |
| | | | | | | | shaped | | | | | | | |
| Example 12 | 12 | PP | 100 | 70 | M1 | 25 | Plate- | 10/1/0.3 | P2 | 19 | 1.3 | A | A | A |
| | | | | | | | shaped | | | | | | | |
| Example 13 | 13 | PP | 100 | 70 | M1 | 25 | Plate- | 10/1/0.3 | P3 | 19 | 1.3 | A | B | A |
| | | | | | | | shaped | | | | | | | |

TABLE 2

| | | | | | | | | | | | Plate- | | | |
|---|---|---|---|---|---|---|---|---|---|---|---|---|---|---|
| | | | | | Filler | | | | | | shaped | | | |
| | | | | | | | | Major axis/ | Phosphate | | minerals/ | Evaluation | | |
| | Compo- | Polyolefin | | | | | | Minor axis/ | ester | | Phosphate | Flame | | Bleed |
| Example | sition | Types | Parts | % | Types | Parts | Shapes | Thickness | Types | Parts | ester | retardancy | Charpy | resistance |
| Comparative | C1 | PP | 100 | 80 | M1 | 25 | Plate- | 10/1/1 | — | 0 | — | C | C | A |
| Example 1 | | | | | | | shaped | | | | | | | |
| Comparative | C2 | PP | 100 | 55 | M1 | 25 | Plate- | 10/1/1 | P1 | 56 | 0.4 | A | C | B |
| Example 2 | | | | | | | shaped | | | | | | | |
| Comparative | C3 | PP | 100 | 93 | M1 | 3 | Plate- | 10/1/1 | P1 | 4 | 0.8 | C | C | B |
| Example 3 | | | | | | | shaped | | | | | | | |
| Comparative | C4 | PP | 100 | 45 | M1 | 75 | Plate- | 10/1/1 | P1 | 48 | 1.6 | B | C | B |
| Example 4 | | | | | | | shaped | | | | | | | |
| Comparative | C5 | PP | 100 | 70 | M3 | 25 | Irregular | 10/10/10 | P1 | 19 | 1.3 | C | C | B |
| Example 5 | | | | | | | shape | | | | | | | |

From the above results, it can be seen that the resin composition and resin molded article of this examples are excellent in the flame retardancy and the mechanical strength.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A resin composition, comprising:
a polyolefin;
a plate-shaped mineral; and
a phosphate ester,
wherein a content of the plate-shaped mineral is from 5 parts by mass to 70 parts by mass with respect to 100 parts by mass of the polyolefin, and
a content of the phosphate ester is from 5 parts by mass to 45 parts by mass with respect to 100 parts by mass of the polyolefin.

2. The resin composition according to claim 1,
wherein the content of the plate-shaped mineral is from 10 parts by mass to 45 parts by mass with respect to 100 parts by mass of the polyolefin, and
the content of the phosphate ester is from 5 parts by mass to 35 parts by mass with respect to 100 parts by mass of the polyolefin.

3. The resin composition according to claim 2,
wherein the content of the plate-shaped mineral is from 15 parts by mass to 30 parts by mass with respect to 100 parts by mass of the polyolefin, and
the content of the phosphate ester is from 15 parts by mass to 32 parts by mass with respect to 100 parts by mass of the polyolefin.

4. The resin composition according to claim 1,
wherein a mass ratio (plate-shaped mineral/phosphate ester) of the content of the plate-shaped mineral to the content of the phosphate ester is from 1/3 to 3/1.

5. The resin composition according to claim 1,
wherein a content of the polyolefin is from 46% by mass to 91% by mass with respect to a total mass of the resin composition.

6. The resin composition according to claim 1,
wherein the polyolefin is polyethylene or polypropylene.

7. The resin composition according to claim 6,
wherein the polyolefin is polypropylene.

8. The resin composition according to claim 1,
wherein the plate-shaped mineral has a major axis of from 0.1 μm to 40 μm, a minor axis of from 0.1 μm to 40 μm, and a thickness of from 0.1 μm to 3 μm.

9. The resin composition according to claim 8,
wherein the plate-shaped mineral is talc or mica.

10. The resin composition according to claim 9,
wherein the plate-shaped mineral is talc.

11. A resin molded article comprising:
the resin composition according to claim 1.

12. The resin molded article according to claim 11, which has a Charpy impact strength of 6 or more.
